(19) United States
(12) Patent Application Publication
(10) Pub. No.: US 2023/0074005 A1
(43) Pub. Date: Mar. 9, 2023

(54) TEMPERATURE MEASUREMENT CIRCUIT

(71) Applicant: GUANGDONG OPPO MOBILE TELECOMMUNICATIONS CORP., LTD., Dongguan (CN)

(72) Inventor: Jun Liu, Dongguan (CN)

(21) Appl. No.: 17/985,619

(22) Filed: Nov. 11, 2022

Related U.S. Application Data
(63) Continuation of application No. PCT/CN2021/085931, filed on Apr. 8, 2021.

(30) Foreign Application Priority Data
May 11, 2020 (CN) 202010393928.6

(51) Int. Cl. G01K 7/16; G01K 7/34

(52) U.S. Cl. CPC G01K 7/16; G01K 7/34

(57) ABSTRACT

Provided is a temperature measurement circuit. The temperature measurement circuit includes a comparator, a first voltage generation circuit, and a second voltage generation circuit. Inputs of the comparator are connected to a voltage output of the first voltage generation circuit and a voltage output of the second voltage generation circuit, respectively, to obtain a reference voltage and a comparison voltage. A comparison result is outputted, and an ambient temperature is determined based on the comparison result. The second voltage generation circuit includes a current generation circuit configured to generate a current signal correlated to the ambient temperature, and a current-to-voltage conversion circuit configured to convert the current signal into the comparison voltage.

### CROSS-REFERENCE TO RELATED APPLICATIONS

This application is a continuation of International Application No. PCT/CN2021/085931, filed on Apr. 8, 2021, which claims a priority to prior Chinese Patent Application No. 202010393928.6, filed on May 11, 2020 and entitled “TEMPERATURE MEASUREMENT CIRCUIT”. The disclosures of the above-mentioned applications are hereby incorporated by reference in their entireties.

### FIELD

The present disclosure relates to temperature measurement technologies, and more particularly, to a temperature measurement circuit.

### BACKGROUND

A Temperature Sensor (TPS) is a circuit configured to convert a temperature into a readable binary code. Temperature monitoring of an integrated circuit chip is of great importance to prevent the chip from being irreversible damaged under a high temperature. In addition, chip performance can be regulated by monitoring the temperature of the integrated circuit chip. In recent years, with a rapid development of a large-scale integrated circuit and the advance in a manufacturing process, the temperature sensor has an increasingly wider commercial application scope. Since temperatures of different nodes inside the chip are not the same, some chips may have a plurality of temperature sensors placed therein to monitor the temperatures of different nodes.

### SUMMARY

To solve the above technical problems, embodiments of the present disclosure provide a temperature measurement circuit.

Implementations of technical solutions of the present disclosure are provided below. A temperature measurement circuit is provided. The temperature measurement circuit includes a comparator, a first voltage generation circuit, and a second voltage generation circuit. A first input of the comparator is connected to an output of the first voltage generation circuit and is configured to obtain a reference voltage outputted by the first voltage generation circuit. A second input of the comparator is connected to an output of the second voltage generation circuit and is configured to obtain a comparison voltage outputted by the second voltage generation circuit. An output of the comparator is configured to output a comparison result. Am ambient temperature is determined based on the comparison result. The second voltage generation circuit includes a current generation circuit configured to generate a current signal correlated to the ambient temperature, and a current-to-voltage conversion circuit configured to convert the current signal into the comparison voltage.

### BRIEF DESCRIPTION OF DRAWINGS

FIG. 1 is a schematic diagram illustrating a first theoretical structure of a temperature measurement circuit according to an embodiment of the present disclosure.

FIG. 2 is a schematic diagram illustrating a second theoretical structure of a temperature measurement circuit according to an embodiment of the present disclosure.

FIG. 3 is a schematic diagram illustrating a third theoretical structure of a temperature measurement circuit according to an embodiment of the present disclosure.

FIG. 4 is a schematic diagram illustrating a fourth theoretical structure of a temperature measurement circuit according to an embodiment of the present disclosure.

FIG. 5 is a schematic structural diagram of a first bandgap reference circuit according to an embodiment of the present disclosure.

FIG. 6 is a schematic structural diagram of a second bandgap reference circuit according to an embodiment of the present disclosure.

### DESCRIPTION OF EMBODIMENTS

In order to provide a more detailed understanding of features and technical content of the present disclosure, implementations of the embodiments of the present disclosure will be described in detail below with reference to the accompanying drawings. The accompanying drawings are used for reference and illustration only, rather than limiting the embodiments of the present disclosure.

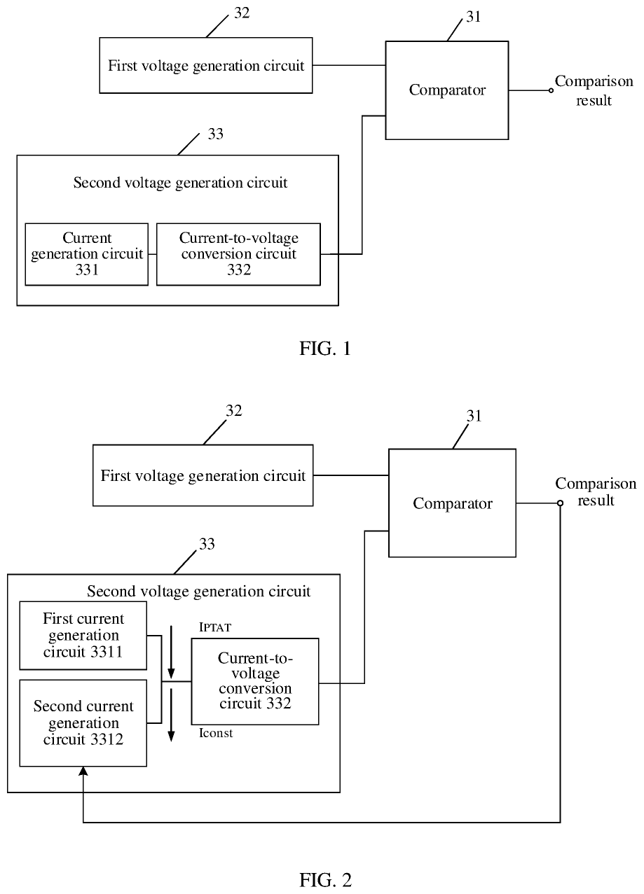

An embodiment of the present disclosure provides a temperature measurement circuit. FIG. 1 is a schematic diagram illustrating a first theoretical structure of a temperature measurement circuit according to an embodiment of the present disclosure. As illustrated in FIG. 1, the temperature measurement circuit includes a comparator 31, a first voltage generation circuit 32, and a second voltage generation circuit 33. A first input of the comparator 31 is connected to an output of the first voltage generation circuit 32 to obtain a reference voltage outputted by the first voltage generation circuit 32. A second input of the comparator 31 is connected to an output of the second voltage generation circuit 33 to obtain a comparison voltage outputted by the second voltage generation circuit 33. An output of the comparator 31 is configured to output a comparison result. An ambient temperature is determined based on the comparison result.

The second voltage generation circuit 33 includes a current generation circuit 331 and a current-to-voltage conversion circuit 332. The current generation circuit 331 is configured to generate a current signal correlated to the ambient temperature. The current-to-voltage conversion circuit 332 is configured to convert the current signal into the comparison voltage.

In a practical application, the comparator may be regarded as a 1-bit Analog-to-Digital Converter (ADC). A first output of the comparator serves as an inverting input, and a fixed reference voltage Vref is applied to the inverting input. A second input of the comparator serves as a non-inverting input, and a comparison voltage Vin is applied to the non-inverting input. A comparison result bs is outputted by an output of the comparator. When Vin is greater than Vref, bs is a high level 1. When Vin is smaller than Vref, bs is a low level 0.

The comparison voltage Vin is converted based on a current signal correlated to a temperature. The number of capacitors required for the sampling and converting of the current signal is smaller than the number of capacitors required by the ADC to sample and process a voltage signal. Therefore, the above embodiment of the present disclosure provides a new voltage generation circuit, capable of reducing the number of capacitors in the entire temperature measurement circuit.

The reference voltage Vref is a voltage, which can be always maintained at a constant value, and a magnitude of which can be determined as desired. Therefore, the first voltage generation circuit includes a voltage stabilization source and a voltage stabilization circuit. The voltage stabilization source can generate a baseline voltage uncorrelated to the temperature. The voltage stabilization circuit can maintain the baseline voltage at the constant value, i.e., the reference voltage. In this way, a voltage fluctuation due to circuit switching or the like can be avoided, to ensure stability of the reference voltage.

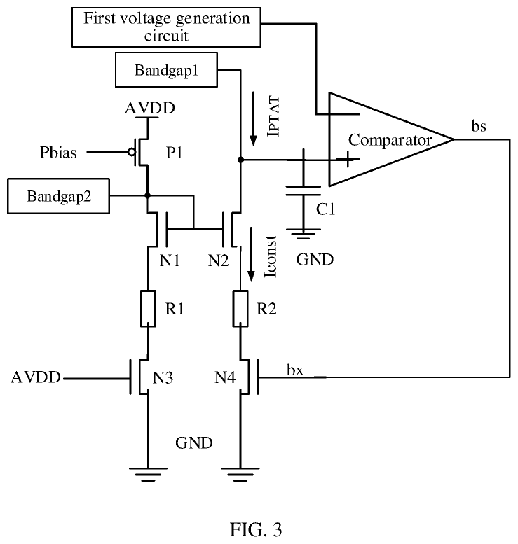

FIG. 2 is a schematic diagram illustrating a second theoretical structure of a temperature measurement circuit according to an embodiment of the present disclosure. In FIG. 2, a specific second voltage generation circuit is provided based on the above embodiment. As illustrated in FIG. 2, the temperature measurement circuit includes a comparator 31, a first voltage generation circuit 32, and a second voltage generation circuit 33.

The second voltage generation circuit 33 includes a current generation circuit 331 and a current-to-voltage conversion circuit 332.

The current generation circuit 331 includes a first current generation circuit 3311 and a second current generation circuit 3312. The first current generation circuit 3311 is configured to output a first current I1 correlated to the ambient temperature. The second current generation circuit 3312 is configured to output a second current I2 uncorrelated to the ambient temperature.

A current input of the current-to-voltage conversion circuit 332 is connected to a current output of the first current generation circuit 3311 and a current output of the second current generation circuit 3312. The current-to-voltage conversion circuit 332 is configured to convert a summed current of the first current and the second current into the comparison voltage.

In some embodiments, the output of the comparator 31 is connected to a current control of the second current generation circuit 3312 and configured to control, based on the comparison result, the second current generation circuit 3312 to output a second current.

That is, the output of the second current is controlled by high- or low-level signals outputted by the comparator to begin or to stop. For example, when the comparison voltage is greater than the reference voltage, the comparison result is a high level, and the second current is controlled to output; and when the comparison voltage is smaller than the reference voltage, the comparison result is a low level, and the output of the second current is controlled to be stopped. That is, when the output of the second current begins, the comparison voltage may be lowered to a voltage lower than the reference voltage; and when the output of the second current is stopped, the comparison voltage may be boosted to a voltage greater than the reference voltage.

For example, the current-to-voltage conversion circuit may be a circuit having a charging and discharging function. The current-to-voltage conversion circuit may be charged by the first current and discharged by the second current. The first current flows into the current-to-voltage conversion circuit from the current input, and the second current flows out of the current-to-voltage conversion circuit from the current input. When the first current and the second current present at the same time, a current at the current input is the summed current of the first current and the second current, and has a current direction same as a direction of a heavy current.

In some embodiments, the current-to-voltage conversion circuit includes a first capacitor. The first capacitor has a first end serving as the current input of the current-to-voltage conversion circuit, and a second end that is grounded. When the comparison result is a low level, an output of the second current is stopped such that the first capacitor is charged with the first current, until a voltage of the first capacitor is greater than the reference voltage and the comparison result changes to a high level. When the comparison result is a high level, the second current is outputted, such that the first capacitor is charged with the first current and the first capacitor is discharged with the second current, until the voltage of the first capacitor is smaller than the reference voltage and the comparison result changes to the low level.

For example, the reference voltage is 1.2v. When an output bs of the comparator is 0, the output of the second current is controlled by bs to stop and the first capacitor is charged by the first current I1, until the first capacitor is charged to 1.2 V, a charging time is hypothetically defined as t0. Then, an output of the comparator is flipped to allow bs to be equal to 1, to output the second current controlled by bs, the first capacitor is discharged and charged simultaneously. In this case, a charging current is still the first current I1 while a discharging current is the second current I2, and a discharging time is hypothetically defined as t1. The overall charging charges are equal to the overall discharging charges, i.e., t0*I1=t1*(I2−I1). Therefore, it can be obtained that a duty cycle μ of bs at the output satisfies μ=t1/(t0+t1)=I1/I2. Since I1 represents that the temperature I2 is uncorrelated to the temperature, and the duty cycle of the output bs also represents the temperature, the ambient temperature can be determined based on the duty cycle of bs.

That is, the first capacitor achieves a conversion between a current and a voltage. The current temperature is characterized by the charging and discharging time of the first capacitor, and the output of the second current is controlled by providing, to the second current generation circuit, feedback of the comparison result, such that a closed-loop control can be formed by the temperature measurement circuit to improve accuracy of a temperature measurement.

In some embodiments, the first current generation circuit includes a first bandgap reference circuit configured to generate the first current.

In some embodiments, the first bandgap reference circuit is further configured to generate a baseline voltage uncorrelated to the ambient temperature; and a voltage input of the first voltage generation circuit is connected to a voltage output of the first bandgap reference circuit, to obtain the reference voltage by performing a voltage regulation on the baseline voltage.

That is, the first bandgap reference circuit may serve as the voltage stabilization source for the first voltage generation circuit and outputs a generated baseline voltage to the voltage stabilization circuit. The voltage stabilization circuit can maintain the baseline voltage at the constant value, i.e., the reference voltage. In this way, problems such as a voltage fluctuation due to circuit switching or the like can be avoided to ensure stability of the reference voltage.

In some other embodiments, the voltage stabilization source of the first voltage generation circuit is a third bandgap reference circuit configured to generate a baseline voltage uncorrelated to the ambient temperature.

In some embodiments, the second current generation circuit includes a second bandgap reference circuit and a current mirror circuit. The second bandgap reference circuit is configured to: generate the second current; and mirror, through the current mirror circuit, the generated second current to the current input of the current-to-voltage conversion circuit.

For example, the current mirror circuit includes a first field effect transistor and a second field effect transistor that are connected in a mirroring arrangement. A current output of the second bandgap reference circuit is connected to a gate electrode and a drain electrode of the first field effect transistor. The drain electrode of the first field effect transistor is connected to a first voltage source. A source electrode of the first field effect transistor is grounded and connected to a source electrode of the second field effect transistor. A drain electrode of the second field effect transistor is connected to the current input of the current-to-voltage conversion circuit. The source electrode of the second field effect transistor is grounded.

Herein, the first field effect transistor and the second field effect transistor are two N-channel Metal Oxide Semiconductor (MOS) field effect transistors. A mirror circuit consisting of two MOS transistors can realize current replication and current purification to ensure the consistency of the second current, thereby further ensuring accuracy of the temperature measurement.

In a practical application, in accordance with a magnitude of a first supply voltage and a magnitude of a control voltage of a gate electrode of a field effect transistor, the first field effect transistor and the second field effect transistor may be two P-channel MOS (PMOS) transistors. In this case, a first PMOS transistor has a source electrode connected to the first voltage source and a grounded drain electrode; and a second PMOS transistor has a source electrode serving as the current input of the current-to-voltage conversion circuit and a grounded drain electrode.

In some embodiments, the current mirror circuit further includes a third field effect transistor and a fourth field effect transistor. The third field effect transistor has a drain electrode connected to the source electrode of the first field effect transistor, a gate electrode connected to a second voltage source, and a grounded source electrode. The fourth field effect transistor has a drain electrode connected to the source electrode of the second field effect transistor, a grounded source electrode, and a gate electrode connected to the output of the comparator. The fourth field effect transistor is controlled to be switched on or off based on the comparison result. When the comparison result is a low level, the fourth field effect transistor is switched off to stop the output of the second current. When the comparison result is high level, the fourth field effect transistor is switched on initiate the output of the second current.

That is, the comparison result is fed back to the gate electrode of the fourth field effect transistor to control the fourth field effect transistor to be switched off or on. When the fourth field effect transistor is switched on, the source electrode of the second field effect transistor is grounded, and the second bandgap reference circuit outputs the second current. When the fourth field effect transistor is switched off, the source electrode of the second field effect transistor can be regarded as being connected to a high resistance, thereby stopping the output of the second current on this path.

In a practical application, the drain electrode of the first field effect transistor is connected to the first voltage source through the PMOS transistor. The PMOS transistor is switched on when the first voltage source is greater than a threshold voltage of the PMOS transistor. The source electrode of the first field effect transistor and the drain electrode of the third field effect transistor are connected to each other through a resistor. The source electrode of the first field effect transistor and the drain electrode of the third field effect transistor are connected to each other through a resistor. The source electrode of the third field effect transistor and the source electrode of the fourth field effect transistor are both grounded through a resistor.

In some embodiments, the first field effect transistor, the second field effect transistor, the third field effect transistor, the fourth field effect transistor, and the first capacitor may be stacked on each other to further reduce an occupied space of a chip.

In some embodiments, the second bandgap reference circuit is further configured to generate a baseline voltage uncorrelated to the ambient temperature; and a voltage input of the first voltage generation circuit is connected to a voltage output of the second bandgap reference circuit, to obtain the reference voltage by performing a voltage regulation on the baseline voltage.

That is, the second bandgap reference circuit can serve as the voltage stabilization source of the first voltage generation circuit, and output the generated baseline voltage to the voltage stabilization circuit. The voltage stabilization circuit can maintain the baseline voltage at a constant value, i.e., the reference voltage. In this way, the problem of the voltage fluctuation due to the circuit switching can be avoided to ensure the stability of the reference voltage.

Based on the above implementations, an embodiment of the present disclosure provides a specific second voltage generation circuit. FIG. 3 is a schematic diagram illustrating a third theoretical structure of a temperature measurement circuit according to an embodiment of the present disclosure. As illustrated in FIG. 3, the temperature measurement circuit includes a comparator, a first voltage generation circuit, and a second voltage generation circuit. The second voltage generation circuit includes a current generation circuit and a current-to-voltage conversion circuit.

The current generation circuit includes a first bandgap reference circuit Bandgap1, a second bandgap reference circuit Bandgap2, and a current mirror circuit.

Bandgap1 generates a first current I_{PTAT} correlated to temperature. Bandgap2 generates a second current Iconst uncorrelated to temperature.

The current mirror circuit includes a first field effect transistor N1, a second field effect transistor N2, a third field effect transistor N3, and a fourth field effect transistor N4. A drain electrode of the first field effect transistor N1 is connected to a first voltage source AVDD through a PMOS transistor P1. A gate electrode of the PMOS transistor P1 is connected to a bias voltage Pbias. A current output of Bandgap2 is connected to a gate electrode and the drain electrode of the first field effect transistor N1. The first field effect transistor N1 is connected to a gate electrode of the second field effect transistor N2. A source electrode of the first field effect transistor N1 is connected to a drain electrode of the third field effect transistor N3 through a resistor R1. A gate electrode of N3 is connected to a second voltage source AVDD. A source electrode of the third field effect transistor N3 is grounded. A drain electrode of the second field effect transistor N2 is connected to a current input of a capacitor C1. The other end of the capacitor C1 is grounded. A source electrode of the second field effect transistor N2 is connected to a drain electrode of the fourth field effect transistor N4 through a resistor R2. A gate electrode bx of the fourth field effect transistor N4 is connected to an output bs of the comparator. A source electrode of the fourth field effect transistor N4 is grounded.

Herein, the current-to-voltage conversion circuit is formed by the capacitor C1; I_{PTAT} is a charging current of the capacitor C1; and Iconst is a discharging current of the capacitor C1. If the charging time is defined as t0 and discharging time is defined as t1, the overall charging charges are equal to the overall discharging charges, i.e., t0*I_{PTAT}=t1*(Iconst−I_{PTAT}). Therefore, it can be obtained that a duty cycle μ of the output bs satisfies μ=t1/(t0+t1)=I_{PTAT}/Iconst. I_{PTAT} represents that the temperature Iconst is uncorrelated to the temperature, and the duty cycle of the output bs also represents the temperature, such that the ambient temperature can be determined based on the duty cycle of bs.

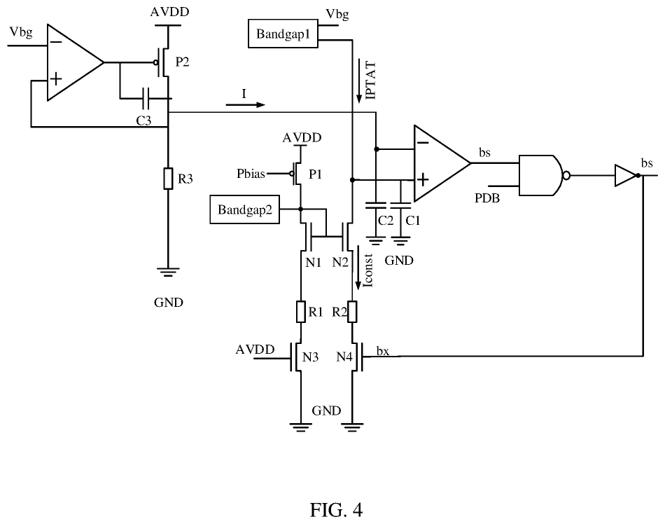

Based on the second voltage generation circuit, an embodiment of the present disclosure further provides a first voltage generation circuit. FIG. 4 is a schematic diagram illustrating a fourth theoretical structure of a temperature measurement circuit according to an embodiment of the present disclosure. As illustrated in FIG. 4, the temperature measurement circuit includes a comparator, a first voltage generation circuit, and a second voltage generation circuit.

The first voltage generation circuit includes a voltage stabilization source and a voltage stabilization circuit. Bandgap1 serves as the voltage stabilization source to generate a baseline voltage Vbg. The voltage stabilization circuit includes an operational amplifier (opamp), a Positive Channel Metal Oxide Semiconductor (PMOS) transistor P2, a capacitor C3, and a resistor R3. A negative input of opamp obtains the baseline voltage Vbg. An output of opamp is connected to a gate electrode of the transistor P2. The transistor P2 has a source electrode connected to the voltage source AVDD and a drain electrode grounded through the resistor R3. Two ends of the capacitor C2 are connected to the gate electrode and the drain electrode of the transistor P2, respectively. A positive input of opamp is connected to the drain electrode of the transistor P2. In this way, a feedback path is formed. Therefore, the stability of a voltage of the capacitor C2, i.e., the reference voltage, can be ensured after the capacitor C2 is charged by the output current I2.

The second voltage generation circuit includes the current generation circuit and the current-to-voltage conversion circuit. The current generation circuit includes the first bandgap reference circuit Bandgap1, the second bandgap reference circuit Bandgap2, and the current mirror circuit.

Bandgap1 can generate a first current I_{PTAT} correlated to the temperature, and Bandgap2 can generate a second current Iconst uncorrelated to the temperature.

The current mirror circuit includes a first field effect transistor N1, a second field effect transistor N2, a third field effect transistor N3, and a fourth field effect transistor N4. A drain electrode of the first field effect transistor N1 is connected to the first voltage source AVDD through the PMOS transistor P1. A gate electrode of the transistor P1 is connected to the bias voltage Pbias. A current output of Bandgap2 is connected to the gate electrode and the drain electrode of the first field effect transistor N1. The first field effect transistor N1 is connected to the gate electrode of the second N2. A source electrode of the first field effect transistor N1 is connected to a drain electrode of the third field effect transistor N3 through a resistor R1. A gate electrode of the third field effect transistor N3 is connected to the second voltage source AVDD. A source electrode of the third field effect transistor N3 is grounded. A drain electrode of the second field effect transistor N2 is connected to a current input of a capacitor C1. The other end of the capacitor C1 is grounded. A source electrode of the second field effect transistor N2 is connected to a drain electrode of the fourth field effect transistor N4 through a resistor R2. A gate electrode bx of the fourth field effect transistor N4 is connected to the output bs of the comparator. The source electrode of N4 is grounded. The voltage source according to the embodiments of the present disclosure may be a same voltage source or different voltage sources.

Herein, the current-to-voltage conversion circuit includes the capacitor C1; I_{PTAT} is a charging current of the capacitor C1; and Iconst is a discharging current of the capacitor C1.

In some embodiments, the first field effect transistor, the second field effect transistor, the third field effect transistor, the fourth field effect transistor, and the first capacitor may be stacked on each other to further reduce the occupied space of the chip.

In practical applications, the output of the comparator may further have a control output logic circuit disposed thereon. The control output logic circuit includes a NAND gate and a NOT gate. Two inputs of the NAND gate include a comparison result bs of the comparator and a control signal PDB. When the control signal is a high level, bs is controlled to be outputted; and when the control signal is a low level, bs is controlled not to be outputted. The outputted bs is fed back to the gate electrode of the fourth field effect transistor N4 and is configured to control the fourth field effect transistor N4 to be switched on or off, thereby controlling an output of the second current Iconst.

In an embodiment of the present disclosure, the first current generated by the first current generation circuit is positively correlated to the ambient temperature. In another embodiment, the first current generated by the first current generation circuit may also be negatively correlated to the ambient temperature.

When temperatures at different points of the chip needs to be detected, with the above temperature measurement circuit, the temperatures at different points can be monitored simply by guiding different IPTATs from the different points of the chip to a core module. In addition, since such a process is a current transmission process, no high requirement is imposed on a length or a width of a transmission line, allowing the process to be easy to implement. Further, only two bandgaps, one opamp, and one comparator are used for the temperature monitoring and conversion, thereby omitting a large number of capacitors. Therefore, compared with a conventional TPS adopting the ADC structure, the area of the chip can be significantly reduced.

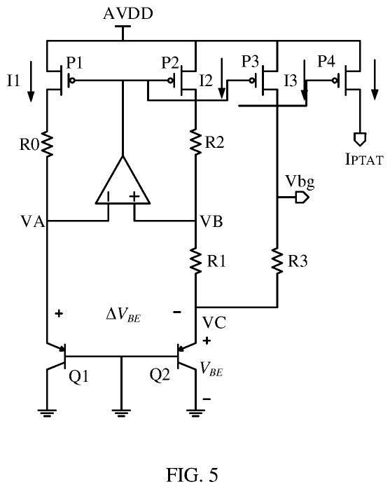

The embodiments of the present disclosure provide schematic structural diagrams of two bandgap reference circuits. FIG. 5 is a schematic structural diagram of a first bandgap reference circuit according to an embodiment of the present disclosure. As illustrated in FIG. 5, the first bandgap reference circuit includes four PMOS transistors P1, P2, P3 and P4, two transistors Q1 and Q2, and resistors R0, R1, R2 and R3.

A mirror structure is formed by the four PMOS transistors P1, P2, P3 and P4. A current I1 on a P1 path is mirrored to each of P2, P3 and P4, and therefore it is obtained that currents I2, I3 and I_{PTAT} are equal to I1. Since voltages VA and VB at two ends of opamp are equal, formulas for deriving the baseline voltage Vbg and the first current I_{PTAT} are as below:

$$\begin{matrix}Vbg = VC + I 3 \cdot R 3 \\ = {V}_{B E} + I 2 \cdot R 3 \\ = {V}_{B E} + \frac{( V B - V C )}{R 1} \cdot R 3 \\ = {V}_{B E} + \frac{R 3}{R 1} \cdot Δ {V}_{B E}\end{matrix} \\ {I}_{P T A T} = I 2 = Δ {V}_{B E} / R 1$$

where ΔV_{BE} has a positive temperature coefficient that is proportional to the temperature; I_{PTAT}, similarly, is also proportional to the temperature; V_{BE} has a negative temperature coefficient that is inversely proportional to the temperature; and Vbg can be a voltage uncorrelated to the temperature by properly selecting R3 and R1.

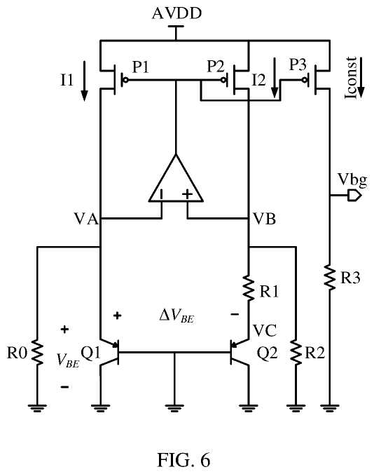

FIG. 6 is a schematic structural diagram illustrating a second bandgap reference circuit according to an embodiment of the present disclosure. As illustrated in FIG. 6, the second bandgap reference circuit includes three PMOS transistors P1, P2 and P3, two transistors Q1 and Q2, and resistors R0, R1, R2 and R3.

A mirror structure is formed by the three PMOS transistors P1, P2 and P3. The current I1 on the P1 path is mirrored to each of P2 and P3, and therefore it is obtained that currents I2 and Iconst are equal to the current I1. Since the voltages VA and VB at the two ends of opamp are equal, formulas for deriving the second current Iconst are as below:

$$\begin{matrix}{I}_{const} = I 2 = {I}_{R 1} + {I}_{R 2} \\ = \frac{V B - V C}{R 1} + \frac{V B}{R 2} \\ = \frac{V A - V C}{R 1} + \frac{V A}{R 2} \\ = \frac{Δ {V}_{B E}}{R 1} + \frac{{V}_{B E}}{R 2}\end{matrix}$$

where ΔV_{BE} has a positive temperature coefficient that is proportional to the temperature; V_{BE} has a negative temperature coefficient that is inversely proportional to the temperature; and Iconst can be a voltage uncorrelated to the temperature by properly selecting R3 and R1.

As illustrated in FIG. 6, the second bandgap reference circuit can also generate the baseline voltage Vbg uncorrelated to the temperature. Therefore, the second bandgap reference circuit may also serve as the voltage source of the first voltage generation circuit to generate the baseline voltage.

With the above temperature measurement circuit, by characterizing the ambient temperature with the current signal correlated to the ambient temperature, a temperature measurement result can be obtained by sampling and processing the current signal. A large number of capacitors, which is required during the sampling and processing of the current signal in an existing temperature measurement circuit, can be omitted, and thus an area of the temperature measurement circuit can be effectively reduced.

The technical solutions described in the embodiments of the present disclosure can be combined with each other arbitrary unless they are contradictory to each other.

It should be understood that, the disclosed embodiments involving the comparator among the several embodiments provided in the present disclosure, the first voltage generation circuit, and the second voltage generation circuit are merely for explaining implementation principles of the temperature measurement circuit of the present disclosure, rather than limiting an actual implementation of the temperature measurement circuit that can be implemented in other ways. The temperature measurement circuit implemented on basis of the above basic principles of the present disclosure shall fall within the protection scope of the present disclosure.

The above are merely several specific embodiments of the present disclosure, while the protection scope of the present disclosure is not limited to these embodiments. Various variants and alternatives without departing from the technical scope of the present disclosure are conceivable to those skilled in the art, and they shall be encompassed by the protection scope of present disclosure.

### INDUSTRIAL APPLICABILITY

The embodiments of the present disclosure provide the temperature measurement circuit, including the comparator, the first voltage generation circuit, and the second voltage generation circuit. The first input of the comparator is connected to the output of the first voltage generation circuit and is configured to obtain the reference voltage outputted by the first voltage generation circuit. The second input of the comparator is connected to the output of the second voltage generation circuit and is configured to obtain the comparison voltage outputted by the second voltage generation circuit. The output of the comparator is configured to output the comparison result. The ambient temperature is determined based on the comparison result. The second voltage generation circuit includes the current generation circuit configured to generate the current signal correlated to the ambient temperature, and the current-to-voltage conversion circuit configured to convert the current signal into the comparison voltage. In this way, through characterizing the ambient temperature with the current signal correlated to the ambient temperature, a temperature measurement result can be obtained by sampling and processing the current signal. A large number of capacitors, which is required during the sampling and processing of the current signal in an existing temperature measurement circuit, can be omitted, and thus an area of the temperature measurement circuit can be effectively reduced.

What is claimed is:

1. A temperature measurement circuit, comprising:
a comparator;
a first voltage generation circuit; and
a second voltage generation circuit, wherein:
a first input of the comparator is connected to an output of the first voltage generation circuit and is configured to obtain a reference voltage outputted by the first voltage generation circuit;
a second input of the comparator is connected to an output of the second voltage generation circuit and is configured to obtain a comparison voltage outputted by the second voltage generation circuit;
an output of the comparator is configured to output a comparison result, an ambient temperature being determined based on the comparison result; and
the second voltage generation circuit comprises a current generation circuit configured to generate a current signal correlated to the ambient temperature, and a current-to-voltage conversion circuit configured to convert the current signal into the comparison voltage.

2. The temperature measurement circuit according to claim 1, wherein:
the current generation circuit comprises a first current generation circuit configured to output a first current correlated to the ambient temperature, and a second current generation circuit configured to output a second current uncorrelated to the ambient temperature;
a current input of the current-to-voltage conversion circuit is connected to a current output of the first current generation circuit and a current output of the second current generation circuit; and
the current-to-voltage conversion circuit is configured to convert a summed current of the first current and the second current into the comparison voltage.

3. The temperature measurement circuit according to claim 2, wherein:
the output of the comparator is connected to a current control of the second current generation circuit; and
the second current generation circuit is configured to output the second current under control of the comparison result.

4. The temperature measurement circuit according to claim 3, wherein:
the current-to-voltage conversion circuit comprises a first capacitor having a first end and a second end, the first end serving as the current input of the current-to-voltage conversion circuit, and the second end being grounded.

5. The temperature measurement circuit according to claim 4, wherein:
in response to the comparison result being a low level, an output of the second current is stopped such that the first capacitor is charged with the first current, until a voltage of the first capacitor is greater than the reference voltage and the comparison result changes to a high level; and
in response to the comparison result being the high level, the second current is outputted, such that the first capacitor is charged with the first current while the first capacitor is discharged with the second current, until the voltage of the first capacitor is smaller than the reference voltage and the comparison result changes to the low level.

6. The temperature measurement circuit according to claim 5, wherein the first current generation circuit comprises a first bandgap reference circuit configured to generate the first current.

7. The temperature measurement circuit according to claim 6, wherein:
the first bandgap reference circuit is further configured to generate a baseline voltage uncorrelated to the ambient temperature; and
a voltage input of the first voltage generation circuit is connected to a voltage output of the first bandgap reference circuit and is configured to obtain the reference voltage by performing a voltage regulation on the baseline voltage.

8. The temperature measurement circuit according to claim 4, wherein the second current generation circuit comprises a second bandgap reference circuit and a current mirror circuit, the second bandgap reference circuit being configured to generate the second current and mirror, through the current mirror circuit, the generated second current to the current input of the current-to-voltage conversion circuit.

9. The temperature measurement circuit according to claim 8, wherein:
the current mirror circuit comprises a first field effect transistor and a second field effect transistor that are connected in a mirroring arrangement;
the first field effect transistor has a gate electrode connected to a current output of the second bandgap reference circuit, a drain electrode connected to the current output of the second bandgap reference circuit and a first voltage source, and a source electrode grounded;
the second field effect transistor has a drain electrode connected to the current input of the current-to-voltage conversion circuit, and a source electrode grounded and connected to the source electrode of the first field effect transistor.

10. The temperature measurement circuit according to claim 9, wherein:
the current mirror circuit further comprises a third field effect transistor and a fourth field effect transistor;
the third field effect transistor has a drain electrode connected to the source electrode of the first field effect transistor, a gate electrode connected to a second voltage source, and a source electrode grounded; and
the fourth field effect transistor has a drain electrode connected to the source electrode of the second field effect transistor, a source electrode grounded, and a gate electrode connected to the output of the comparator, the fourth field effect transistor being controlled to be switched on or off based on the comparison result.

11. The temperature measurement circuit according to claim 10, wherein:
in response to the comparison result being the low level, the output of the second current is stopped by switching off the fourth field effect transistor; and
in response to the comparison result being the high level, the second current is outputted by switching on the fourth field effect transistor.

12. The temperature measurement circuit according to claim 11, wherein the first field effect transistor, the second field effect transistor, the third field effect transistor, the fourth field effect transistor, and the first capacitor are stacked on each other.

13. The temperature measurement circuit according to claim 2, wherein the first current generated by the first current generation circuit is positively correlated to the ambient temperature.

14. The temperature measurement circuit according to claim 7, wherein the first voltage generation circuit comprises:
a voltage stabilization source configured to generate a baseline voltage uncorrelated to the temperature; and
a voltage stabilization circuit configured to maintain the baseline voltage at the reference voltage.

15. The temperature measurement circuit according to claim 14, wherein the first bandgap reference circuit serves as the voltage stabilization source of the first voltage generation circuit to output the baseline voltage generated by the first bandgap reference circuit to the voltage stabilization circuit.

16. The temperature measurement circuit according to claim 14, wherein:
the voltage stabilization circuit comprises an operational amplifier, a Positive Channel Metal Oxide Semiconductor (PMOS) transistor, a capacitor, and a resistor;
the operational amplifier has a negative input configured to obtain the baseline voltage, a positive input connected to a drain electrode of the PMOS transistor, and an output connected to a gate electrode of the PMOS transistor;
a source electrode of the PMOS transistor is connected to a voltage source, and a drain electrode of the PMOS transistor is grounded through the resistor of the operational amplifier; and
two ends of the capacitor are connected to the gate electrode of the PMOS transistor and the drain electrode of the PMOS transistor.

17. An integrated circuit chip, comprising a temperature measurement circuit,
the temperature measurement circuit comprising:
a comparator;
a first voltage generation circuit; and
a second voltage generation circuit, wherein:
a first input of the comparator is connected to an output of the first voltage generation circuit and is configured to obtain a reference voltage outputted by the first voltage generation circuit;
a second input of the comparator is connected to an output of the second voltage generation circuit and is configured to obtain a comparison voltage outputted by the second voltage generation circuit;
an output of the comparator is configured to output a comparison result, an ambient temperature being determined based on the comparison result; and
the second voltage generation circuit comprises a current generation circuit configured to generate a current signal correlated to the ambient temperature, and a current-to-voltage conversion circuit configured to convert the current signal into the comparison voltage.
